(19) United States
(12) Patent Application Publication
(10) Pub. No.: US 2008/0122899 A1
(43) Pub. Date: May 29, 2008

(54) INKJET PRINT HEAD AND METHOD OF MANUFACTURING THE SAME

(75) Inventors: Moon-chul LEE, Yongin-si (KR); Byung-ha Park, Suwon-si (KR); Dong-sik Shim, Suwon-si (KR); Yong-seop Yoon, Seoul (KR); Sung-joon Park, Suwon-si (KR); Yong-won Jeong, Seoul (KR); Kyong-il Kim, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/778,289

(22) Filed: Jul. 16, 2007

(30) Foreign Application Priority Data
Nov. 27, 2006 (KR) 2006-117921

(51) Int. Cl. B41J 2/17; B23P 17/00; B41J 2/05; B21D 53/76

(52) U.S. Cl. 347/65; 347/94; 29/890.1

(57) ABSTRACT

An inkjet print head includes a substrate in which an ink feed hole having an hourglass cross-section is formed, a chamber layer that is stacked on the substrate and has a plurality of ink chambers into which ink supplied from the ink feed hole is filled, and a nozzle layer that is stacked on the chamber layer and has a plurality of nozzles through which the ink is ejected.

### CROSS-REFERENCE TO RELATED APPLICATIONS

This application claims priority under 35 U.S.C § 119(a) from Korean Patent Application No. 10-2006-0117921, filed on Nov. 27, 2006, in the Korean Intellectual Property Office, the disclosure of which is incorporated herein in its entirety by reference.

### BACKGROUND OF THE INVENTION

1. Field of the Invention

The present general inventive concept relates to an inkjet print head, and more particularly, to an inkjet print head having a stable and reliable structure and a method of manufacturing the same.

2. Description of the Related Art

An inkjet print head is a device to print a predetermined color image by ejecting minute droplets of ink on a desired area of a printing paper. Inkjet print head can be generally classified into two types according to an ejection mechanism of ink droplets. The first type is a thermal inkjet print head that ejects ink droplets using the expansion force of ink bubbles created using a heat source, and the second type is a piezoelectric inkjet print head that ejects inkjet droplets using a pressure created by deformation of a piezoelectric element.

The ejection mechanism of ink droplets of the thermal inkjet print head will be described in detail. When a pulse type current is applied to a heater composed of heating resistors, ink around the heater is instantly heated to approximately 300° C. Thus, the ink boils and thus, ink bubbles are generated. Then, pressure is applied to the ink filled in an ink chamber by expansion of the ink bubbles. As a result, ink near nozzles is ejected to outside from the ink chamber through the nozzles in a droplet shape.

FIG. 1 is a cross-sectional view illustrating a conventional thermal inkjet print head. Referring to FIG. 1, the conventional thermal inkjet print head includes a substrate 10 on which a plurality of material layers are formed, a chamber layer 20 stacked on the plurality of material layers, and a nozzle layer 30 stacked on the chamber layer 20. A plurality of ink chambers 22, in which ink that is to be ejected is filled, are formed in the chamber layer 20. A plurality of nozzles 32 through which ink is ejected are formed in the nozzle layer 30. An ink feed hole 11 to supply ink to the ink chambers 22 is formed in the substrate 10. Also, a plurality of restrictors 24 that connect the ink chambers 22 and the ink feed hole 11 are formed in the chamber layer 20.

An insulating layer 12 to insulate a plurality of heaters 14 from the substrate 10 is formed on the substrate 10. The heaters 14 are formed on the insulating layer 12 to generate ink bubbles by heating ink. Electrodes 16 are formed on the heaters 14. A passivation layer 18 to protect the heaters 14 and the electrodes 16 is formed on surfaces of the heaters 14 and electrodes 16. Anti-cavitation layers 19 to protect the plurality of heaters 14 from a cavitation force generated when ink bubbles disappear are formed on the passivation layer 18.

In manufacturing an inkjet print head having the above structure, the ink feed hole 11 can be formed by wet etching the substrate 10 exposed through an etch mask until the substrate 10 is perforated after the etch mask is formed on a rear surface of the substrate 10. However, in the wet etching process of forming the ink feed hole 11 through the substrate 10, misalignment of the ink feed hole 11 can occur, and as a result, distances between the ink feed hole 11 and the ink chambers 22 can be non-uniform. Also, there is a process limitation of the wet etching process to correctly form a desired shape of the ink feed hole 11. Accordingly, when the ink feed hole 11 is formed in the substrate 10 using the wet etching process, ejection characteristic of each of the nozzles 32 is non-uniform, and as a result, an inkjet print head that has a stable and reliable structure cannot be obtained.

### SUMMARY OF THE INVENTION

The present general inventive concept provides an inkjet print head that has a stable and reliable structure and a method of manufacturing the inkjet print head.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an inkjet print head including a substrate in which an ink feed hole having an hourglass cross-sectional shape is formed, a chamber layer that is stacked on the substrate and has a plurality of ink chambers into which ink supplied from the ink feed hole is filled, and a nozzle layer that is stacked on the chamber layer and has a plurality of nozzles through which the ink is ejected.

The ink feed hole may include of a first feed hole which is formed in an upper portion of the substrate and having a width that is gradually reduced along a downward direction, a second feed hole which is formed in a lower portion of the substrate and having a width that is gradually reduced along an upward direction, and a third feed hole to connect the first and second feed holes. The third feed hole may have a constant width.

The ink feed hole may be formed through the substrate. The ink chamber layer may further include a plurality of restrictors that connect the ink feed hole and the ink chambers.

The inkjet print head may further include an insulating layer on an upper surface of the substrate, and a plurality of heaters to generate ink bubbles by heating the ink in the ink chambers may be formed in the insulating layer, and a plurality of electrodes to apply a current to the heaters may be formed on the heaters.

The inkjet print head may further include a passivation layer formed on the insulating layer to cover the heaters and the electrodes and an anti-cavitation layer formed on the passivation layer located on the upper portions of the heaters to protect the heaters from a cavitation pressure generated when ink bubbles disappear.

A trench that is connected to the ink feed hole may be formed in the passivation layer and the insulating layer.

The foregoing and/or other aspects and utilities of the present general inventive concept may also be achieved by providing a method of manufacturing an inkjet print head, including forming an insulating layer and an etch mask layer, respectively, on upper and lower surfaces of a substrate, sequentially forming heaters and electrodes on the insulating layer, forming a trench to expose the upper surface of the substrate in the insulating layer, forming a chamber layer having a plurality of ink chambers on the insulating layer, forming an etch mask by patterning the etch mask layer, forming first and second feed holes on the upper and lower portions of the substrate by respectively etching the upper surface of the substrate exposed through the trench and the lower surface of the substrate exposed through the etch mask, forming a nozzle layer having a plurality of nozzles on the chamber layer and forming a third feed hole to connect the first and second feed holes by etching the substrate between the first and second feed holes.

The method may further include forming a passivation layer covering the heaters and the electrodes on the insulating layer after the forming of the heaters and the electrodes. The trench may be formed by sequentially etching the passivation layer and the insulating layer.

The method may further include forming an etch protection layer on the insulating layer and the chamber layer after the chamber layer is formed.

The first and second feed holes may be respectively formed by wet etching the upper surface of the substrate exposed through the trench and the lower surface of the substrate exposed through the etch mask. The third feed hole may be formed by dry etching the substrate between the first and second feed holes.

The forming of the nozzle layer may include forming a sacrificial layer to fill the first feed hole, the trench, and the ink chambers, stacking a nozzle material layer on the sacrificial layer and the chamber layer, and forming the nozzles that expose the sacrificial layer by patterning the nozzle material layer.

The method may further include planarizing an upper surface of the sacrificial layer after the sacrificial layer is formed.

The method may also further include removing the sacrificial layer through the nozzles and the third feed hole after the third feed hole is formed, and removing the etch mask after the sacrificial layer is removed.

The insulating layer and the etch mask layer may be respectively formed by oxidizing the upper and lower surfaces of the substrate.

The foregoing and/or other aspects and utilities of the present general inventive concept may also be achieved by providing an inkjet print head, including a plurality of nozzles, a plurality of ink chambers to eject ink through the plurality of nozzles and one or more ink feed channels to feed the ink to the plurality of ink chambers, the one or more ink feed channels each having an upper portion, a lower portion and a middle portion connecting the upper and lower portions, wherein a width of the upper portion gradually decreases along a downward direction, a width of the lower portion gradually decreases along an upward direction and a width of the middle portion is substantial constant.

The foregoing and/or other aspects and utilities of the present general inventive concept may also be achieved by providing a method of forming an ink feed channel in an inkjet print head, including etching a substrate at a predetermined angle to form an upper portion of the ink feed channel having a width that gradually decreases along a downward direction, etching the substrate at a predetermined angle to form a lower portion of the ink feed channel having a width that gradually decreases along an upward direction and etching the substrate to form a middle portion having a substantially constant width of the ink feed channel connecting the upper and lower portion.

The foregoing and/or other aspects and utilities of the present general inventive concept may also be achieved by providing a method of fabricating an inkjet print head, including forming an insulation layer, a mask layer, heaters and electrodes on a surface of a substrate, forming a trench to expose the insulation layer, forming ink chambers on upper portions of the heaters and forming first and second feed holes through the trench and at a back of the substrate, respectively, simultaneously using a wet etching process such that a width of the first and second feed holes gradually decrease while approaching each other.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a schematic cross-sectional view illustrating a conventional thermal inkjet print head;

FIG. 2 is a schematic plan view illustrating an inkjet print head according to an embodiment of the present general inventive concept;

FIG. 3 is a cross-sectional view taken along a line III-III′ of FIG. 2, according to an embodiment of the present general inventive concept; and

FIGS. 4 through 12 are cross-sectional views illustrating a method of manufacturing an inkjet print head according to an embodiment of the present general inventive concept.

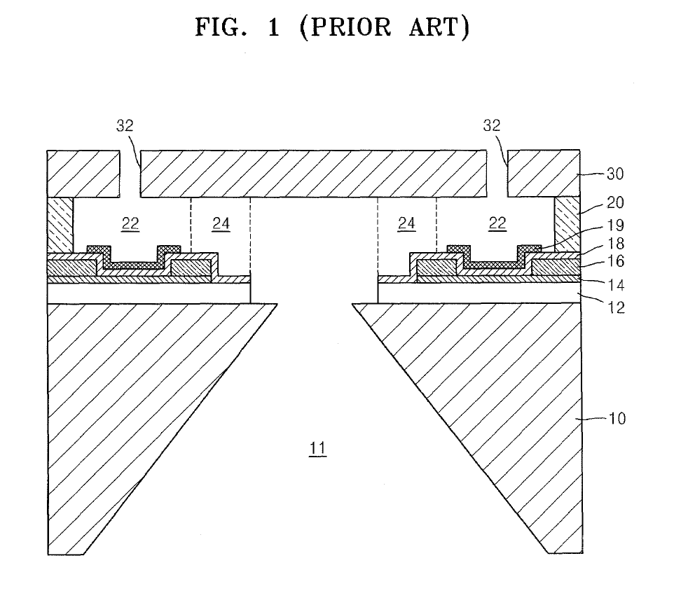

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

It will also be understood that when a layer is referred to as being “on” another layer or substrate, it can be directly on the other layer or substrate, or intervening layers may also be present. Like reference numerals in the drawings denote like elements. Also, each of the elements that constitute an inkjet print head can be formed of a material different from the material described herein. Also, the methods of stacking and forming material layers described herein are also examplary, and thus various methods of stacking and forming material layers besides those described herein can be employed. Also, in the method of manufacturing the inkjet print head, the sequence of operations may be different from the examplary embodiments of the present general inventive concept.

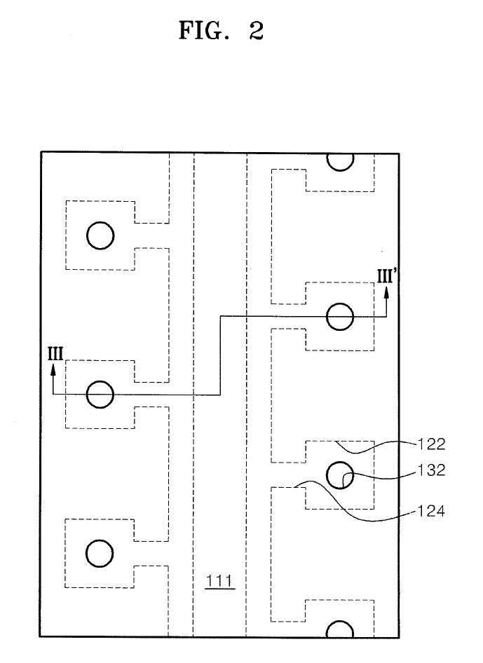

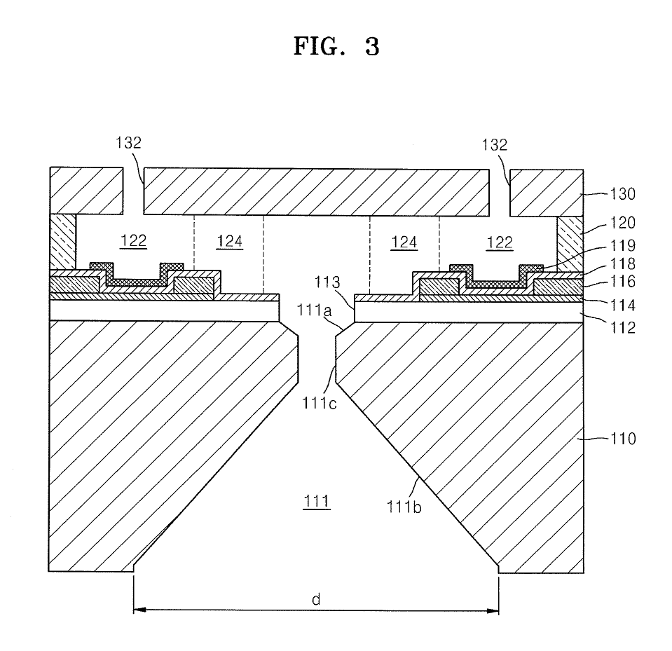

FIG. 2 is a schematic plan view illustrating an inkjet print head according to an embodiment of the present general inventive concept, and FIG. 3 is a cross-sectional view taken along a line III-III′ of FIG. 2.

Referring to FIGS. 2 and 3, the inkjet print head according to an embodiment of the present general inventive concept includes a substrate 110 on which a plurality of material layers are formed, a chamber layer 120 formed on the plurality of material layers, and a nozzle layer 130 stacked on the chamber layer 120. A plurality of ink chambers 122 are formed in the chamber layer 120, and a plurality of nozzles 132 are formed in the nozzle layer 130.

The substrate 110 can be a silicon substrate. An ink feed hole 111 to supply ink is formed through the substrate 110. In the present embodiment, the cross-section of the ink feed hole 111 may have an hourglass shape. More specifically, the ink feed hole 111 can include a first feed hole 111a formed in an upper portion of the substrate 110, a second feed hole 111b formed in a lower portion of the substrate 110, and a third feed hole 111c that connects the first feed hole 111a and the second feed hole 111b. The first feed hole 111a has a width that is gradually reduced along a downward direction, and the second feed hole 111b has a width that is gradually reduced along an upward direction. The third feed hole 111c has a constant width. In FIG. 3, one ink feed hole 111 is formed in the substrate 110, but the present general inventive concept is not limited thereto. That is, a plurality of ink feed holes 111 can be formed corresponding to colors of inks.

An insulating layer 112 to insulate heaters 114 from the substrate 110 can be formed on an upper surface of the substrate 110. The insulating layer 112 can be formed of, for example, a silicon oxide. The heaters 114 to generate ink bubbles by heating the ink in the ink chambers 122 are formed on an upper surface of the insulating layer 112. The heaters 114 can be located on a lower portion of the ink chambers 122. The heaters 14 can be formed of a heating resistor composed of, for example, an alloy of tantalum-aluminum, tantalum-nitride, titanium-nitride, or tungsten-silicide. Electrodes 116 to apply a current to the heaters 114 are formed on upper surfaces of the heaters 114. The electrodes 116 can be formed of a material having high electrical conductivity, for example, Al, an Al alloy, Au, or Ag.

A passivation layer 118 can further be formed on the upper surfaces of the electrodes 116 and the heaters 114. The passivation layer 118 prevents the heaters 114 and the electrodes 116 from being oxidized or corroded by contacting ink, and can be formed of, for example, a silicon oxide or silicon nitride. Anti-cavitation layers 119 can further be formed on upper surfaces of the passivation layers 118 that constitute bottoms of the ink chambers 122. The anti-cavitation layers 119 protect the heaters 114 from a cavitation pressure generated when the ink bubbles disappear, and can be formed of, for example, tantalum (Ta). A trench 113 that is connected to the first feed hole 111a is formed in the passivation layer 118 and the insulating layer 112.

The chamber layer 120 is formed on the substrate 110 on which a plurality of material layers are formed. The ink chambers 122 into which ink supplied from the ink feed hole 111 are formed in the chamber layer 120. The ink chambers 122 are located on upper portions of both sides of the ink feed hole 111. The chamber layer 120 can further include a plurality of restrictors 124 which are paths to connect the ink feed hole 111 to the ink chambers 122. The nozzle layer 130 is stacked on the chamber layer 120, and includes nozzles 132 through which ink is ejected to the outside. The nozzles 132 can be located on upper portions of the ink chambers 122.

As described above, in the inkjet print head according to an embodiment of the present general inventive concept, the cross-section of the ink feed hole 111 formed through the substrate 110 has an hourglass shape. Accordingly, as described in the subsequent manufacturing process, ink can be uniformly supplied to the ink chambers 122 from the ink feed hole 111. Accordingly, an ejection characteristic of the nozzles 132 is uniform, thereby being possible to realize a stable and reliable inkjet print head. The first and second feed holes 111a and 111b of the ink feed hole 111 are formed simultaneously by wet etching the substrate 110. In the wet etching process, etching of the substrate 110 is performed at a predetermined angle with respect to a surface of the substrate 110. Therefore, in the inkjet print head according to an embodiment of the present general inventive concept, the ink feed hole 111 formed in the lower portion of the substrate 110 has a predetermined width d. When the width d of the ink feed hole 111 formed in the lower portion of the substrate 110 is reduced, an inkjet print head having a very robust structure can be manufactured. Also, when a plurality of ink feed holes are formed to a number of colors of inks to be used, the mixing of inks having different colors between adjacent ink feed holes can be effectively prevented when an inkjet print head according to an embodiment of the present general inventive concept is coupled to ink cartridges.

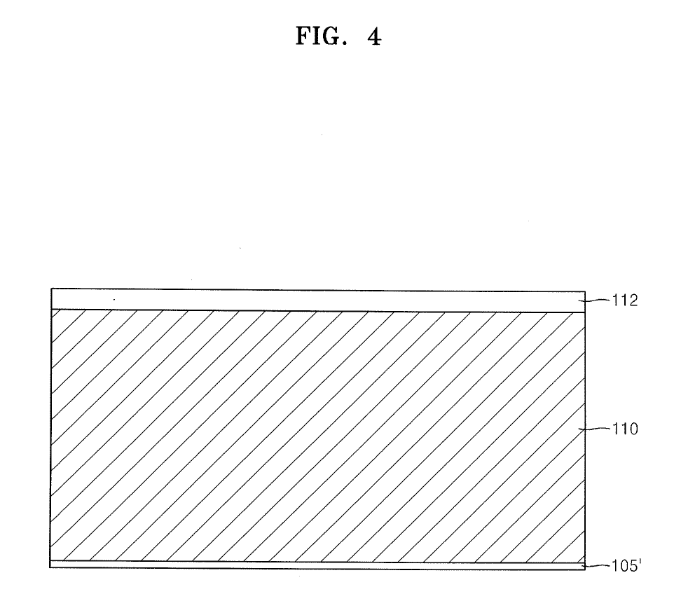

A method of manufacturing an inkjet print head according to an embodiment of the present general inventive concept will now be described. FIGS. 4 through 12 are cross-sectional views illustrating a method of manufacturing an inkjet print head according to an embodiment of the present general inventive concept.

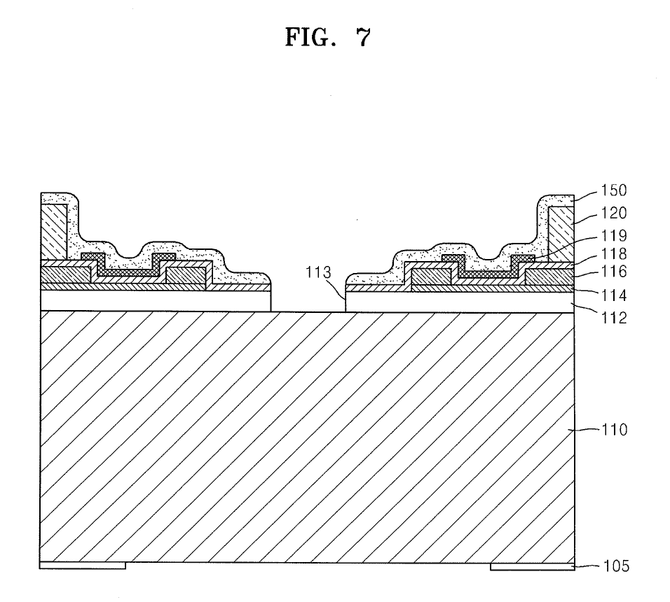

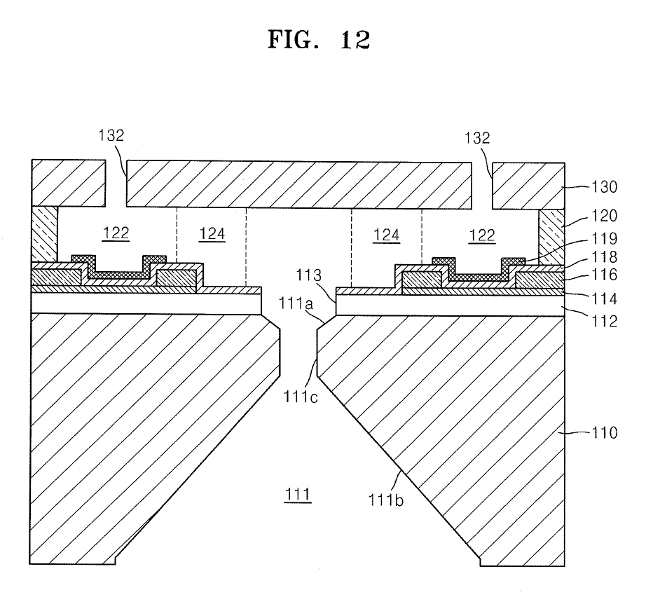

Referring to FIG. 4, after preparing a substrate 110, an insulating layer 112 and an etch mask layer 105′ are respectively formed on upper and lower surfaces of the substrate 110. The substrate 110 can be a silicon substrate. The insulating layer 112 insulates the substrate 110 from the heaters 114 formed on the insulating layer 112. The etch mask layer 105′ is used as an etch mask 105 (FIG. 7) to form a second feed hole 111b of an ink feed hole 111 (FIG. 12) in a subsequent patterning process. The insulating layer 112 and the etch mask layer 105′ can be formed by oxidizing the upper and lower surfaces of the substrate 110. The insulating layer 112 and the etch mask layer 105′ can be formed of, for example, a silicon oxide.

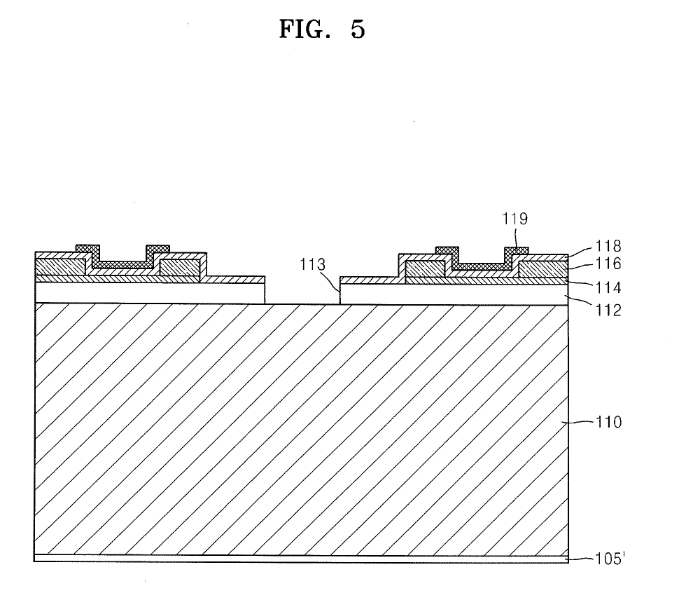

Referring to FIG. 5, the heaters 114 to generate bubbles by heating ink are formed on an upper surface of the insulating layer 112. The heaters 114 can be formed by patterning a heating resistor with, for example, an alloy of tantalum-aluminum, tantalum-nitride, titanium-nitride, or tungsten-silicide after depositing the heating resistor on the insulating layer 112. Electrodes 116 to apply a current to the heaters 114 are formed on upper surfaces of the heaters 114. The electrodes 116 can be formed by patterning a material having high electrical conductivity, for example, Al, an Al alloy, Au, or Ag after depositing the material on the upper surfaces of the heaters 114.

Next, a passivation layer 118 covering the electrodes 116 and the heaters 114 can further be formed on the upper surface of the insulating layer 112. The passivation layer 118 prevents the heaters 114 and the electrodes 116 from being oxidized or corroded by contacting ink, and generally can be formed of, for example, a silicon oxide or silicon nitride. Anti-cavitation layers 119 can further be formed on upper surfaces of the passivation layers 118 that constitute bottoms of the ink chambers 122. The anti-cavitation layers 119 protect the heaters 114 from a cavitation pressure generated when the ink bubbles break, and generally can be formed of, for example, tantalum (Ta). Next, a trench 113 that exposes the upper surface of the substrate 110 is formed by sequentially etching the passivation layer 118 and the insulating layer 112. The trench 113 can be formed on the upper portion of the ink feed hole 111 formed in the subsequent process. The heaters 114 and the electrodes 116 are located on both sides of the trench 113.

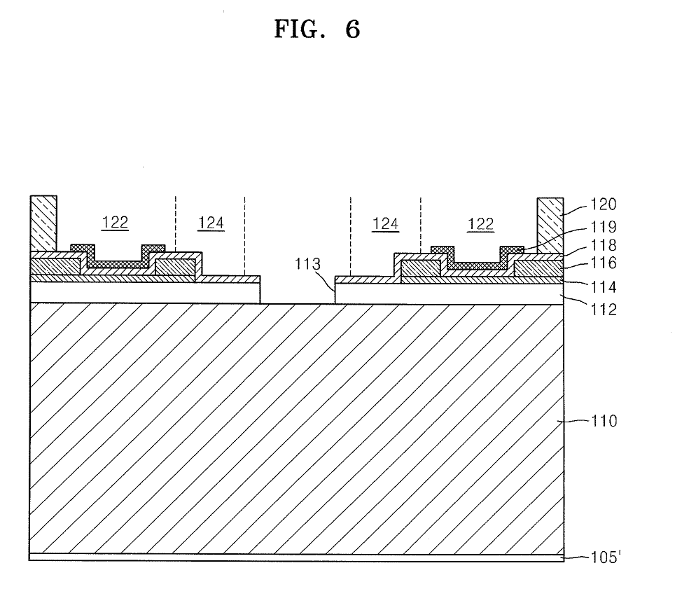

Referring to FIG. 6, a chamber layer 120 in which ink chambers 122 are formed is formed on the passivation layer 118. More specifically, the chamber layer 120 can be formed by patterning a chamber material layer after the chamber material layer that covers the structure depicted in FIG. 5 is deposited to a predetermined thickness. At this point, the ink chambers 122 can be formed on the upper portions of the heaters 114. The chamber layer 120 can further include a plurality of restrictors 124 which are paths to connect the ink chambers 122 to the ink feed hole 111.

Referring to FIG. 7, an etch mask 105 that exposes a lower surface of the substrate 110 is formed by patterning the etch mask layer 105′ formed on the lower surface of the substrate 110. An etch protection layer 150 can be formed on the passivation layer 118 and the chamber layer 120. After coating a predetermined material on the structure depicted in FIG. 6, the etch protection layer 150 can be formed by patterning the material until the trench 113 can be exposed. The etch protection layer 150 protects the chamber layer 120, the passivation layer 118, the heaters 114, and the electrodes 116 in a subsequent process of wet etching the substrate 110. Therefore, the etch protection layer 150 may be formed of a material having etch selectivity with respect to the substrate 110.

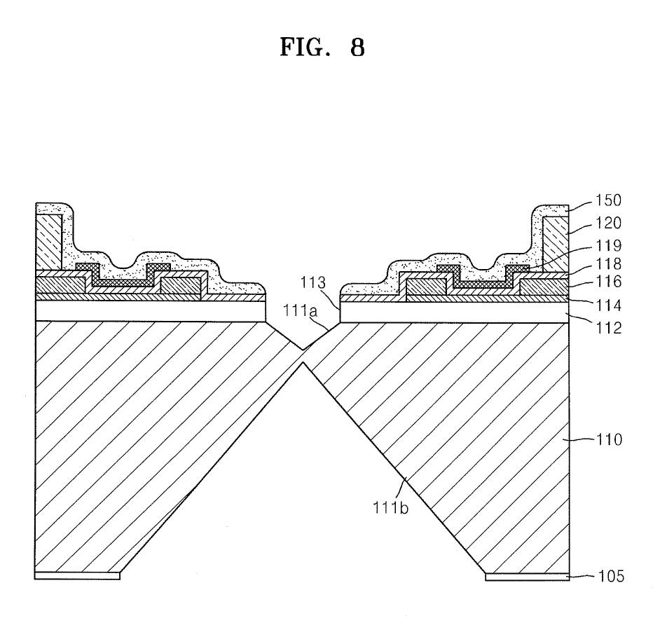

Referring to FIG. 8, first and second feed holes 111a and 111b are respectively formed on the upper and lower portions of the substrate 110 by etching the upper surface of the substrate 110 exposed through the trench 113 and the lower surface of the substrate 110 exposed through the etch mask 105. The etching of the substrate 110 may be performed by a wet etching process using an etchant such as tetramethyl ammonium hydroxide (TMAH). Accordingly, when the upper and lower surfaces of the substrate 110 are etched, as depicted in FIG. 8, the etching of the substrate 110 proceeds at a predetermined angle with respect to the surface of the substrate 110. As a result, the first feed hole 111a, a width of which is gradually reduced along a downward direction in the upper portion of the substrate 110, and the second feed hole 111b, a width of which is gradually reduced along an upward direction in the lower portion of the substrate 110, are formed. Next, the etch protection layer 150 is removed.

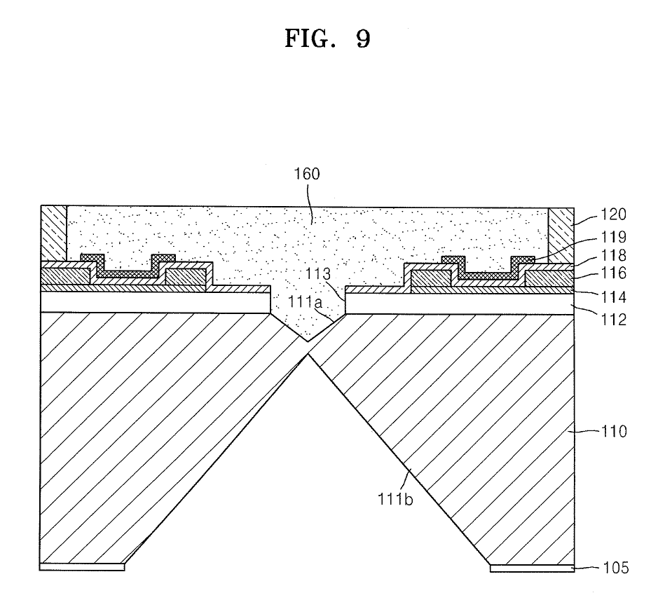

Referring to FIG. 9, a sacrificial layer 160 that fills the first feed hole 111a, the trench 113, the ink chambers 122, and the restrictors 124 is formed. Next, an upper surface of the sacrificial layer 160 is planarized using a polishing method, for example, a chemical mechanical polishing (CMP) method.

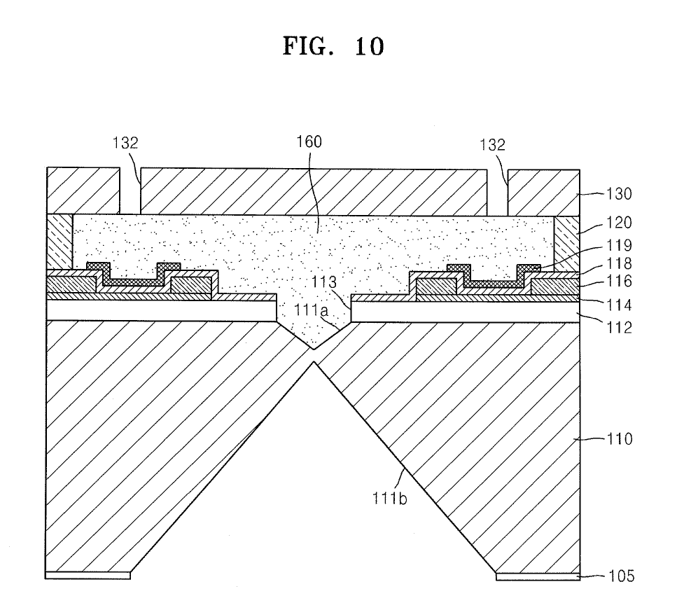

Referring to FIG. 10, a nozzle layer 130 in which a plurality of nozzles 132 are formed is formed on upper surfaces of the chamber layer 120 and the sacrificial layer 160. After forming a nozzle material layer on the upper surfaces of the chamber layer 120 and the sacrificial layer 160, the nozzle layer 130 can be formed by patterning the nozzle material layer. Accordingly, the plurality of nozzles 132 that expose the upper surface of the sacrificial layer 160 are formed in the nozzle layer 130. The nozzles 132 can be formed on the upper portions of the ink chambers 122.

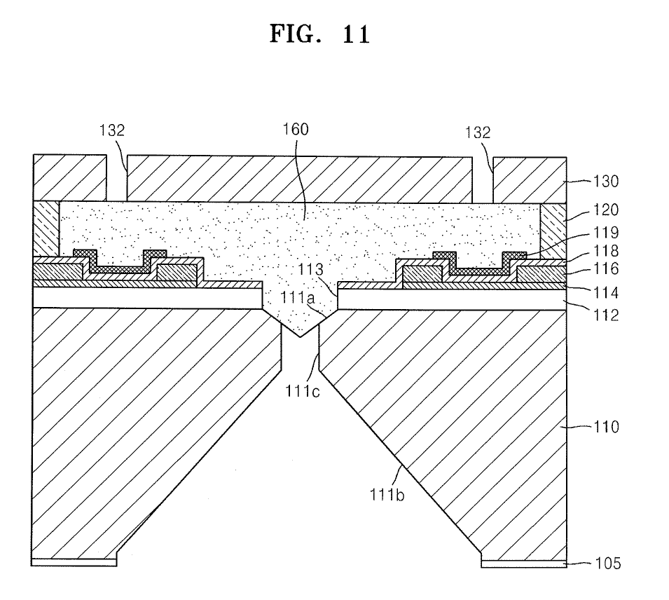

Referring to FIG. 11, a third feed hole 111c that connects the first and second feed holes 111a and 111b is formed by etching the substrate 110 between the first and second feed holes 111a and 111b. The third feed hole 111c can be formed by dry etching the substrate 110 between the first and second feed holes 111a and 111b until a lower surface of the sacrificial layer 160 is exposed. The third feed hole 111c having a uniform width can be formed by the dry etching process.

Referring to FIG. 12, the sacrificial layer 160 filled in the ink chambers 122, the restrictors 124, the trench 113, and the first feed hole 111a is removed. The sacrificial layer 160 can be removed by injecting a predetermined etchant through the nozzles 132 and the second and third feed holes 111b and 111c. As a result, the ink chambers 122 and the restrictors 124 are formed in the chamber layer 120, and the ink feed hole 111 whose cross-section has an hourglass shape is formed through the substrate 110. The ink feed hole 111 includes of the first feed hole 111a formed to be connected to the trench 113 in the upper portion of the substrate 110, the second feed hole 111b formed in the lower portion of the substrate 110, and the third feed hole 111c that connects the first and second feed holes 111a and 111b. The first feed hole 111a has a width that is gradually reduced along a downward direction, the second feed hole 111b has a width that is gradually reduced along an upward direction, and the third feed hole 111c has a constant width.

As described above, in a method of manufacturing an inkjet print head according to an embodiment of the present general inventive concept, since the first feed hole 111a of the ink feed hole 111, which is formed in the upper portion of the substrate 110, is formed by etching the upper surface of the substrate 110 exposed through the trench 113, distances between the first feed hole 111a and the ink chambers 122 can be uniform. Accordingly, ink can be uniformly supplied to each of the ink chambers 122 from the ink feed hole 111. Also, the first and second feed holes 111a and 111b respectively formed in the upper and lower portions of the substrate 110 are simultaneously formed by etching the upper surface of the substrate 110 exposed through the trench 113 and by etching the lower surface of the substrate 110 exposed through the etch mask 105. In the wet etching process, the etching of the substrate 110 is performed at a predetermined angle with respect to the surfaces of the substrate 110. Therefore, the ink feed hole 111 formed in the lower portion of the substrate 110 has a predetermined width d (FIG. 3).

As described above, an inkjet print head according to the present general inventive concept allows ink to be uniformly supplied to ink chambers from an ink feed hole and the ink feed hole formed in the lower portion of the substrate to have a relatively small width.

Ink can be uniformly supplied to ink chambers from an ink feed hole since the distances between a first feed hole which is formed in an upper portion of a substrate and the ink chambers can be formed uniform. Accordingly, the ejection characteristic of nozzles is uniform, thereby realizing a stable and reliable inkjet print head.

Since first and second feed holes of the ink feed hole respectively formed in upper and lower portions of the substrate are simultaneously formed by wet etching the upper and lower surfaces of the substrate, the ink feed hole formed in the lower portion of the substrate has a predetermined width. Therefore, an inkjet print head having a robust structure can be manufactured. Also, when a plurality of ink feed holes are formed corresponding to a number of colors of inks to be used, the mixing of inks having different colors between adjacent ink feed holes can be effectively prevented when the inkjet print head according to the present general inventive concept is coupled to ink cartridges.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. An inkjet print head, comprising:
a substrate in which an ink feed hole having an hourglass cross-section is formed;
a chamber layer that is stacked on the substrate and has a plurality of ink chambers into which ink supplied from the ink feed hole is filled; and
a nozzle layer that is stacked on the chamber layer and has a plurality of nozzles through which the ink is ejected.

2. The inkjet print head of claim 1, wherein the ink feed hole comprises:
a first feed hole which is formed in an upper portion of the substrate and having a width that is gradually reduced along a downward direction;
a second feed hole which is formed in a lower portion of the substrate and having a width that is gradually reduced along an upward direction; and
a third feed hole that connects the first and second feed holes.

3. The inkjet print head of claim 2, wherein the third feed hole has a constant width.

4. The inkjet print head of claim 1, wherein the ink feed hole is formed through the substrate.

5. The inkjet print head of claim 1, wherein the ink chambers are located proximate to the upper portions of both sides of the ink feed hole.

6. The inkjet print head of claim 1, wherein the ink chamber layer further comprises:
a plurality of restrictors that connect the ink feed hole and the ink chambers.

7. The inkjet print head of claim 1, wherein the nozzles are located proximate to the upper portions of the ink chambers.

8. The inkjet print head of claim 1, further comprising:
an insulating layer on an upper surface of the substrate.

9. The inkjet print head of claim 8, wherein a plurality of heaters to generate ink bubbles by heating the ink in the ink chambers are formed on the insulating layer, and a plurality of electrodes to apply a current to the heaters are formed on the heaters.

10. The inkjet print head of claim 1, further comprising:
a passivation layer formed on the insulating layer to cover the heaters and the electrodes.

11. The inkjet print head of claim 1, further comprising:
an anti-cavitation layer formed on the passivation layer located on the upper portions of the heaters to protect the heaters from a cavitation pressure generated when ink bubbles disappear.

12. The inkjet print head of claim 10, wherein a trench that is connected to the ink feed hole is formed in the passivation layer and the insulating layer.

13. A method of manufacturing an inkjet print head, comprising:
forming an insulating layer and an etch mask layer, respectively, on upper and lower surfaces of a substrate;
sequentially forming heaters and electrodes on the insulating layer;
forming a trench to expose the upper surface of the substrate in the insulating layer;
forming a chamber layer having a plurality of ink chambers on the insulating layer;
forming an etch mask by patterning the etch mask layer;
forming first and second feed holes on the upper and lower portions of the substrate by respectively etching the upper surface of the substrate exposed through the trench and the lower surface of the substrate exposed through the etch mask;
forming a nozzle layer having a plurality of nozzles on the chamber layer; and
forming a third feed hole to connect the first and second feed holes by etching the substrate between the first and second feed holes.

14. The method of claim 13, further comprising:
forming a passivation layer covering the heaters and the electrodes on the insulating layer after the forming of the heaters and the electrodes.

15. The method of claim 14, wherein the trench is formed by sequentially etching the passivation layer and the insulating layer.

16. The method of claim 15, wherein the heaters and the electrodes are located on both sides of the trench.

17. The method of claim 14, further comprising:
forming an anti-cavitation layer on the passivation layer located on the upper portions of the heaters after the passivation layer is formed.

18. The method of claim 13, further comprising:
forming an etch protection layer on the insulating layer and the chamber layer after the chamber layer is formed.

19. The method of claim 13, wherein the first and second feed holes are respectively formed by wet etching the upper surface of the substrate exposed through the trench and the lower surface of the substrate exposed through the etch mask.

20. The method of claim 19, wherein:
a width of the first feed hole gradually reduces along a downward direction; and
a width of the second feed hole gradually reduces along an upward direction.

21. The method of claim 19, wherein an etchant for wet etching comprises tetramethyl ammonium hydroxide (TMAH).

22. The method of claim 13, wherein the third feed hole is formed by dry etching the substrate between the first and second feed holes.

23. The method of claim 22, wherein the third feed hole is formed to have a constant width.

24. The method of claim 13, wherein the forming of the nozzle layer comprises:
forming a sacrificial layer to fill the first feed hole, the trench, and the ink chambers;
stacking a nozzle material layer on the sacrificial layer and the chamber layer; and
forming the nozzles that expose the sacrificial layer by patterning the nozzle material layer.

25. The method of claim 24, further comprising:
planarizing an upper surface of the sacrificial layer after the sacrificial layer is formed.

26. The method of claim 24, further comprising:
removing the sacrificial layer through the nozzles and the third feed hole after the third feed hole is formed.

27. The method of claim 26, further comprising:
removing the etch mask after the sacrificial layer is removed.

28. The method of claim 13, wherein the insulating layer and the etch mask layer are respectively formed by oxidizing the upper and lower surfaces of the substrate.

29. An inkjet print head, comprising:
a plurality of nozzles;
a plurality of ink chambers to eject ink through the plurality of nozzles; and
one or more ink feed channels to feed the ink to the plurality of ink chambers, the one or more ink feed channels each having an upper portion, a lower portion and a middle portion connecting the upper and lower portions;
wherein a width of the upper portion gradually decreases along a downward direction, a width of the lower portion gradually decreases along an upward direction and a width of the middle portion is substantial constant.

30. The inkjet print head of claim 1, wherein a number of the one or more ink feed channels correspond to a number of different colors inks being used.

31. A method of forming an ink feed channel in an inkjet print head, comprising:
etching a substrate at a predetermined angle to form an upper portion of the ink feed channel having a width that gradually decreases along a downward direction;
etching the substrate at a predetermined angle to form a lower portion of the ink feed channel having a width that gradually decreases along an upward direction; and
etching the substrate to form a middle portion having a substantially constant width of the ink feed channel connecting the upper and lower portion.

32. The method of claim 31, wherein the upper and lower portions are formed by simultaneously performing wet etching on the substrate.

33. The method of claim 32, wherein the middle portion is formed by performing dry etching on the substrate through the upper and lower portion.

34. A method of fabricating an inkjet print head, comprising:
forming an insulation layer, a mask layer, heaters and electrodes on a surface of a substrate;
forming a trench to expose the insulation layer;
forming ink chambers on upper portions of the heaters; and
forming first and second feed holes through the trench and at a back of the substrate, respectively, simultaneously using a wet etching process such that a width of the first and second feed holes gradually decrease while approaching each other.

35. The method of claim 34, wherein the forming the second feed hole further includes forming an etch mask layer on the back of the substrate and patterning the etch mask layer.

36. The method of claim 35, wherein the forming the first and second feed holes further includes forming an etch protection layer on the heaters, electrodes and trench by coating a material thereon and then patterning the material until the trench is exposed before etching.
